(19) United States
(12) Patent Application Publication
(10) Pub. No.: US 2009/0094077 A1
(43) Pub. Date: Apr. 9, 2009

(54) Site development planning

(76) Inventors: Bryn Fosburgh, (US); LaVonne Lynette Frazier, Arvada, CO (US); Peter Graham Gipps, Heatherton (AU)

Correspondence Address: TRIMBLE NAVIGATION LIMITED C/O WAGNER BLECHER, 123 WESTRIDGE DRIVE, WATSONVILLE, CA, 95076, US

(21) Appl. No.: 11/973,663

(22) Filed: Oct. 9, 2007

(51) Int. Cl. G06Q 10/00; G06F 17/10; G06F 17/40; G06F 19/00

(52) U.S. Cl. 705/7

(57) ABSTRACT

In a computer implemented method for site development planning, a development mix is automatically determined for developing a site. The development mix is based upon a location of the site and regulatory information regarding the site location. An earthworks parameter for the site is automatically estimated from the development mix. A site build phase parameter is automatically determined from the development mix. One or more of the development mix, site earthworks parameter, and site build phase parameter are then provided as a site development planning output.

### BACKGROUND

Site development planning is currently a manually intensive and time consuming process through which information such as costs, schedules, income streams, and other information related to a development scenario for a particular site (e.g., a parcel of undeveloped or reconditioned land) is estimated. Site development planning is typically performed by one or more people and encompasses one or more sub-processes, such as: determining a development mix (e.g. the type and number of structures to be built); planning for the earthworks which will be performed on a site (e.g., planning for earthmoving assets, costs, and timelines involving site preparation); and planning the building which will occur on a site (e.g., determining a sequence of building structures, costs of building structures, and an estimated timeline for building structures).

As currently performed, site development planning may take days, weeks, or longer depending upon the size of the development, number of sources from which information must be gathered, number of tradeoffs that need to be explored, and other factors. Because each sub-process often shapes determinations, outputs, schedules, and/or estimates of follow-on sub-processes, a change made during site development planning often has a ripple effect which may slow the site development process down or cause it to be started over.

### SUMMARY

In a computer implemented method for site development planning, a development mix is automatically determined for developing a site. The development mix is based upon a location of the site and regulatory information regarding the site location. An earthworks parameter for the site is automatically estimated from the development mix. A site build phase parameter is automatically determined from the development mix. One or more of the development mix, site earthworks parameter, and site build phase parameter are then provided as a site development planning output.

### BRIEF DESCRIPTION OF THE DRAWINGS

The accompanying drawings, which are incorporated in and form a part of this application, illustrate embodiments of the present technology for site development planning, and together with the description, serve to explain the principles of the present technology. Unless noted, the drawings referred to this description should be understood as not being drawn to scale.

FIG. 1 is a block diagram of an example computer system used in accordance with an embodiment.

FIG. 2 shows plan view of a site, in accordance with one embodiment.

FIG. 3 is a block diagram of an example site development planning system, in accordance with one embodiment.

FIG. 4 is an example user interface for a site development planning system, in accordance with one embodiment.

FIG. 5 is a block diagram of an example development mix module, in accordance with one embodiment.

FIG. 6 is a flow diagram of an example method for determining a development mix for a site, in accordance with one embodiment.

FIG. 7 shows a site plan visualization, in accordance with one embodiment.

FIG. 8 is a block diagram of an example earthworks module, in accordance with one embodiment.

FIG. 9 is a flow diagram of an example method for estimating a site earthworks parameter, in accordance with one embodiment.

FIG. 10 shows an example topographical map for a site, in accordance with one embodiment.

FIG. 11 is a block diagram of an example build module, in accordance with one embodiment.

FIG. 12 is a flow diagram of an example method for determining a site build phase parameter, in accordance with one embodiment.

FIG. 13 is a flow diagram of an example method for site development planning, in accordance with one embodiment.

### DETAILED DESCRIPTION

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope as defined by the appended claims. Furthermore, in the following description, numerous specific details are set forth in order to provide a thorough understanding of the present technology. In other instances, well-known methods, procedures, objects, and circuits have not been described in detail as not to unnecessarily obscure aspects of the present technology.

### Notation and Nomenclature

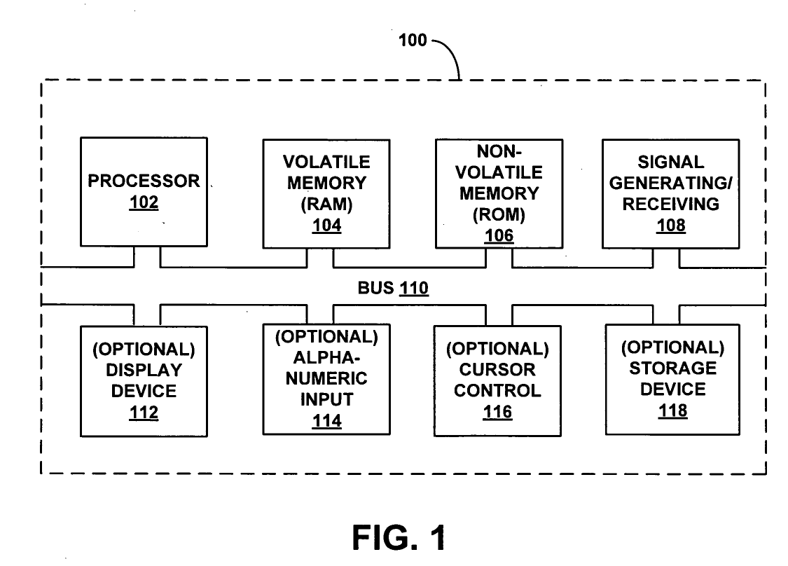

Unless specifically stated otherwise as apparent from the following discussions, it is appreciated that throughout the present detailed description, discussions utilizing terms such as “determining”, “estimating”, “providing”, “receiving”, “retrieving”, “generating”, “utilizing”, “selecting”, “coupling”, “outputting”, or the like, refer to the actions and processes of a computer system (such as computer system 100 of FIG. 1), or similar electronic computing device. Computer system 100 or similar electronic computing device manipulates and transforms data represented as physical (electronic) quantities within the computer system's registers and memories into other data similarly represented as physical quantities within the computer system memories or registers or other such information storage, transmission, or display devices.

The present technology may be described in the general context of computer-executable instructions, such as modules, which are executed or executable by a computer. Generally, these modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, modules may be located in both local and remote computer-storage media including memory-storage devices.

As described herein, the term “site” refers to a parcel of land, either undeveloped or reconditioned land. Some examples of a site include: a lot in a development plan, a parcel of land in an area zoned for a particular type of use, and a parcel of land as denoted by a legal description or some other description of its location.

### Overview of Discussion

The technology presented herein automates or semi-automates elements of the site development planning process. This allows a site development planning process that may have taken days weeks or months when performed in an existing manner, to now be performed much more quickly. Additionally, while a site development planning process performed in an existing manner would typically rely upon input from numerous skilled persons such as businesspersons, architects, engineers, and developers, the site development planning process as described herein relies only on minor inputs from a user, such as supplying location information regarding a site upon which development planning is to be performed. Thus as compared to previous methods of site development planning, this significantly reduces the skill level and the number of individuals required to perform site development planning. Moreover, methods of site development planning described herein significantly lessen the data collection burden upon the user through the automation of the retrieval of information such as regulatory information, geographic information, earthmoving asset specifications, and area specific build information.

Discussion will begin with a description of an example computer system environment with which, or upon which, embodiments of the present technology may operate. An example site, for which site development planning may be performed, will be presented. Discussion will proceed to a description of an example site development planner. A general description of the operation of the components of this site development planner will be provided. Overall operation of the site development planner and the modules and components of the site development planner will then be described in more detail in conjunction with example methods of operation.

### Example Computer System Environment

With reference now to FIG. 1, a block diagram is shown of an embodiment of an example computer system 100 which may be used in accordance with various embodiments described herein. It should be appreciated that computing system 100 is not strictly limited to being a computer system. As such, computer system 100 of the present embodiment may be well suited to be any type of computing device (e.g., real time server computer, web server, networked computer, portable computing device, desktop computer, mobile phone, personal digital assistant, and etc.). Within the discussions herein, certain processes and steps are discussed that are realized, in one embodiment, as a series of instructions (e.g., software program) that reside within computer readable memory units and are executed by a processor(s) of computing system 100. When executed, the instructions cause computer system 100 to perform specific actions and exhibit specific behavior that may be described in detail herein.

Computer system 100 of FIG. I comprises an address/data bus 1 10 for communicating information, one or more central processors 102 coupled with bus 110 for processing information and instructions. Central processor unit(s) 102 may be a microprocessor or any other type of processor. Computer system 100 also includes data storage features such as a computer usable volatile memory unit 104 (e.g., random access memory, static RAM, dynamic RAM, etc.) coupled with bus 110 for storing information and instructions for central processor(s) 102, a computer usable non-volatile memory unit 106 (e.g., read only memory, programmable ROM, flash memory, EPROM, EEPROM, etc.) coupled with bus 110 for storing static information and instructions for processor(s) 102. Computer system 100 also includes one or more signal generating and receiving devices 108 coupled with bus 110 for enabling computer system 100 to interface with other electronic devices and computer systems. The communication interface(s) 108 of the present embodiment may include wired and/or wireless communication technology.

Optionally, computer system 100 may include an alphanumeric input device 114 including alphanumeric and function keys coupled to the bus 110 for communicating information and command selections to the central processor(s) 102. Computer system 100 can include an optional cursor control or cursor directing device 116 coupled to the bus 110 for communicating user input information and command selections to the central processor(s) 102. The cursor-directing device 116 may be implemented using a number of well-known devices such as a mouse, a track-ball, a track-pad, an optical tracking device, and a touch screen, among others. Alternatively, it is appreciated that a cursor may be directed and/or activated via input from the alphanumeric input device 114 using special keys and key sequence commands. The present embodiment is also well suited to directing a cursor by other means such as, for example, voice commands.

Computing system 100 of FIG. 1 may also include one or more optional computer usable data storage devices 118 such as a magnetic or optical disk and disk drive (e.g., hard drive, floppy diskette, Compact Disk-Read Only Memory (CD-ROM), Digital Versatile Disk (DVD)) coupled with bus 110 for storing information and/or computer executable instructions. An optional display device 112 may be coupled to bus 110 of computing system 100 for displaying video and/or graphics. It should be appreciated that optional display device 112 may be a cathode ray tube (CRT), flat panel liquid crystal display (LCD), field emission display (FED), plasma display or any other display device suitable for displaying video and/or graphic images and alphanumeric characters recognizable to a user.

### Example Site

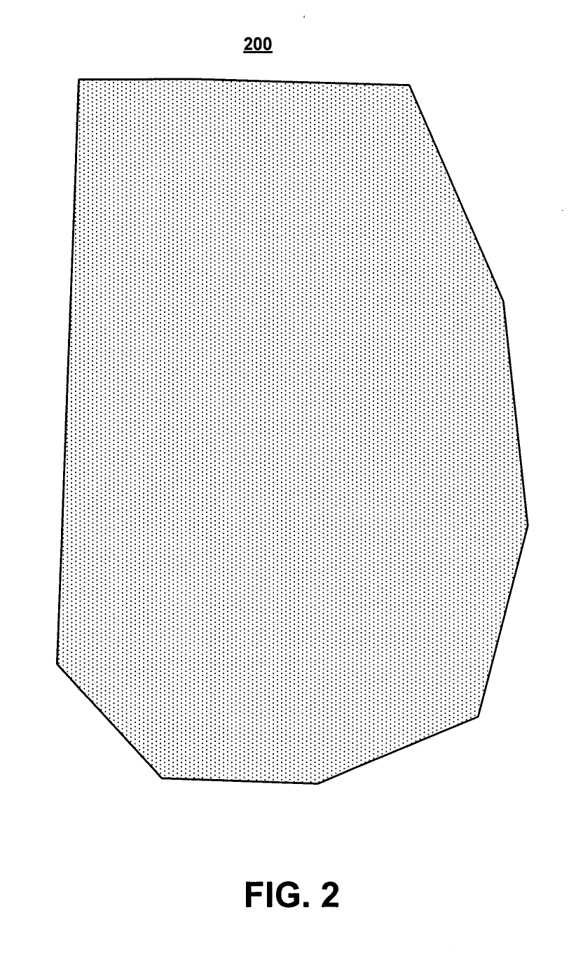

FIG. 2 shows a plan view example of a site 200 for which development planning may be performed. As shown in FIG. 2, site 200 is a plot of undeveloped land, such as a lot in a sub-division or a parcel of land in a commercial or industrial development area.

### Example Site Development Planning System

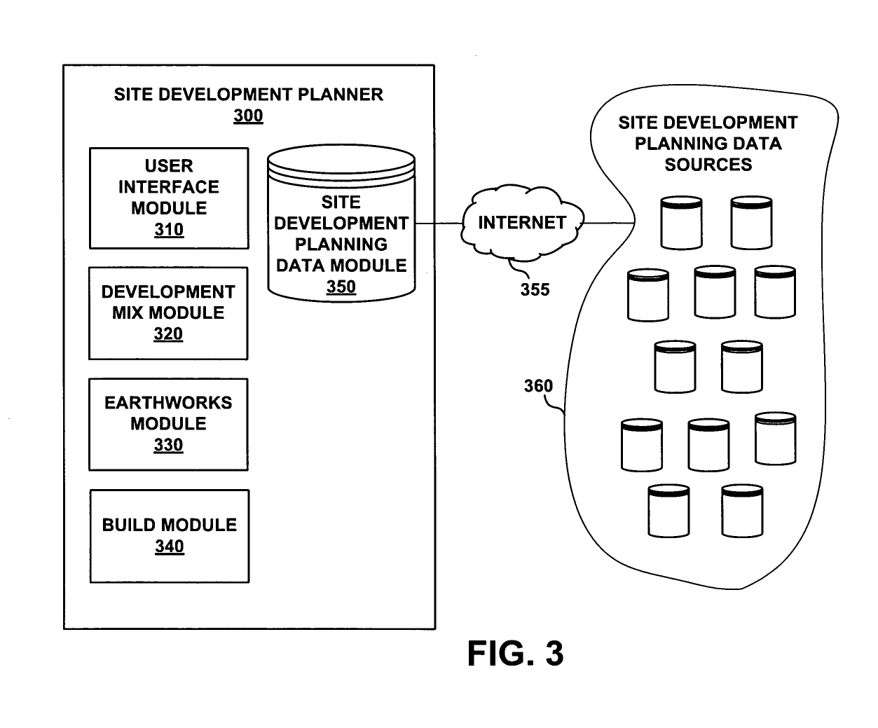

Referring now to FIG. 3, a block diagram is shown of an example site development planner 300. As will be further described herein, site development planner 300 is used by user to plan development of a site, such as site 200. In one embodiment, site development planner 300 is implemented as instructions that are resident on or executed by a computer system, such as computer system 100. In other embodiments, elements of site development planner are located on a network accessible computer 100, such as a server, such that site development planning is performed at a central location as a service for users at network connected locations.

As shown in FIG. 3, site development planner 300 is comprised of a user interface module 310, a development mix module 320, an earthworks module 330, a build module 340, and a site development planning data module 350. It is appreciated that the modules and components of site development planner 300 are coupled with and configured to exchange data with one another as required for the performance of site development planning.

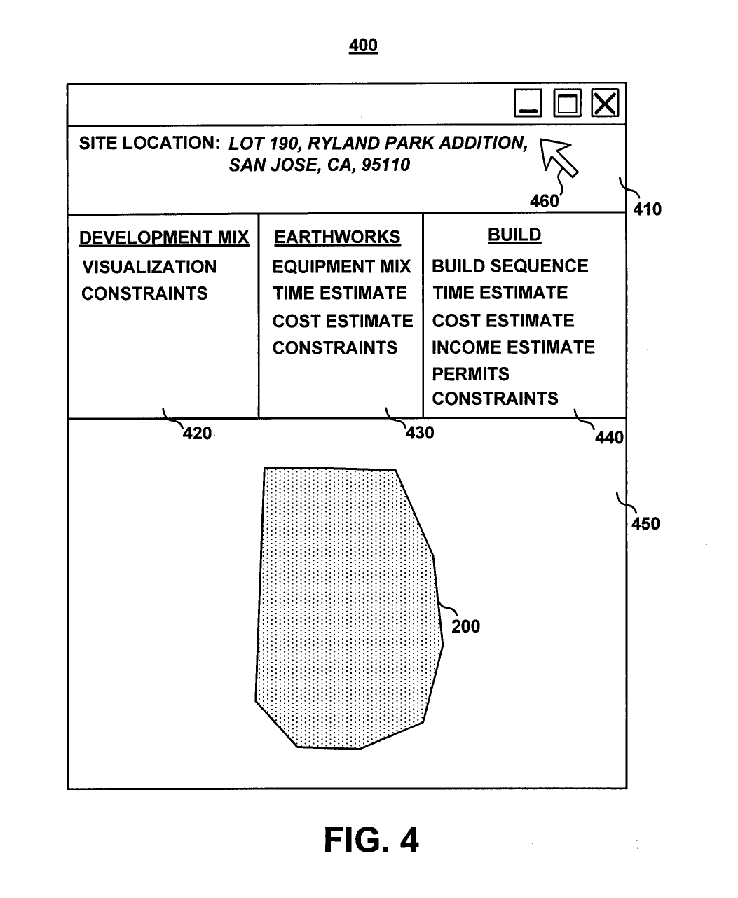

User interface module 310 provides a user interface mechanism for receiving input from a user. Some examples of user inputs include receiving the location of a site from a user, allowing a user to select/modify functions of site development planning which will be performed, and for presenting site development planning information to a user. In one embodiment, user interface module 310 presents a user interface in the form of a graphical user interface on a display device, such as display device 112 of computer system 100. One example of such a user interface presented by user interface module 310 is user interface 400, shown in FIG. 4.

With reference to FIG. 4, an example user interface 400 is shown. User interface 400 provides a graphical user interface for a user to interact with site planner 300. For example, by using cursor 460 or other selecting mechanism, a user may select site location input region 410, and then input location information (such as by typing) a description of the location of a site to perform development planning for. In response, in one embodiment, site planner 300 causes a plan view of site 200 to be displayed in display region 450. Additionally, through use of cursor 460 or other selecting mechanism, a user may add one or more constraints to phases of site development planning and may elect for site planning information to be displayed in display region 450 of user interface 400.

For example, by choosing a selectable option such as, for example, “CONSTRAINTS” in development mix region 420, a user is presented with a dialog box or other input mechanism which allows development mix limitations to be selected and/or deselected. Similarly, by choosing a selectable option, such as, for example, “VISUALIZATION” in development mix region 420, a user causes site development planner 300 to display a site plan visualization in display region 450. Likewise, by choosing a selectable option in earthworks region 430 and/or build region 440, a user may also cause particular site planning information to be displayed, cause a particular input mechanism to be activated, and/or add constraints. It is appreciated that user interface 400 displays, various site planning outputs of site planner 300. For example, in various embodiments, display region 450 displays a development mix, a build phase parameter, and/or an earthworks parameter.

With reference again to FIG. 3, development mix module 320 automatically determines a development mix for developing a site. The development mix is based upon a location of the site and regulatory information regarding the site location. In one embodiment, such a development mix is automatically determined based upon regulatory information (such as zoning regarding the development mix) which is retrieved by development mix module 320. A basic form of a development mix is a listing of the numbers and types of structures that are to be built upon a site. Of course other information such as the size or location of the structures may be provided along with this basic information. Such an automatically generated development mix complies with zoning and other regulatory requirements for a site. Therefore, if a site is zoned for residential use, commercial and industrial structures are not included in the development mix that is determined for the site. For instance, assume that site 200 is zoned for commercial and retail development. In such an instance, an example of a basic development mix generated by development mix module 320 for site 200 is four commercial buildings and two retail buildings.

Earthworks module 330 estimates one or more site earthworks parameters for a site development mix and, in one embodiment, provides the estimate of such parameter(s) to a user. The development mix upon which such earthworks parameters are based may be user provided, automatically generated by development mix module 320, or some combination. The term “earthworks” refers generally to the work performed to perform cut (removal of material) and/or fill (addition of material) upon a site to prepare it for the pouring of foundations for structures which are to be built on the site. Earthmoving assets such as: scrapers, dozers, backhoes, compactors, graders, dump trucks, and the like, are typically employed to perform earthworks for a site. Some examples of earthworks parameters include: a time estimate for performing the earthworks; an estimate of an earthmoving asset mix needed to perform the earthworks; an estimate of a schedule for performing the earthworks (e.g., a list (mix) of earthmoving assets needed along with an timeline for when in the schedule and for how long each earthmoving asset will be needed); an estimate of the cost for performing the earthworks; and an estimate of the personnel needed to perform the earthworks (e.g., number, skill sets, amount of time).

Build module 340 determines one or more site build phase parameters for a site development mix and, in one embodiment, provides the estimate of such parameter(s) to a user. The development mix upon which such build parameters are based may be user provided, automatically generated by development mix module 320, or some combination. Some examples of site build phase parameters include: an estimate of the total cost to construct structures of the development mix; an automatically generated build sequence for building structures of the development mix; an estimate of the net present value for one or more particular build sequences; an estimate of a timeline for completion of a particular build sequence; an estimate of rental rates for structures of a development mix; an estimate of the cash flow generated by one or more build sequences, and an estimate of a build sequence which will maximize cash flow.

Site development planning data module 350 comprises a source for retrieving site development planning data. In one embodiment, site development planning data module 350 comprises a store of pre-parsed site development planning data that has been retrieved and assembled from a variety of sources. In another embodiment, site development planning data module 350 comprises a mechanism for coupling to and retrieving information from a variety of site development planning data sources 360 which are accessible via the Internet 355 or other network. For example, such site development planning data sources 360 include: title, deed, zoning, building code, building permit, and environmental regulations maintained within network accessible websites and databases of local, county, state, and national governments. Such site development planning data sources also include network accessible websites and databases websites of: retail companies (e.g., databases of big box retail companies which build numerous structures); title companies; geographical information sources (e.g., Google Earth, DigitalGlobe, TerraServer, the National Geospace Intelligence Agencey (NGS), the Center for Earth Resources Observation and Science (EROS), or the United States Geological Survey); rental rate sources; prevailing wage sources; earthmoving asset manufacturers and renters; traffic study sources; and various private and publicly available construction information sources. In one embodiment, site development planning data module 350 comprises a combination of stored pre-parsed site development planning data and one or more links to network accessible site development planning data sources 360.

### Example Methods of Operation

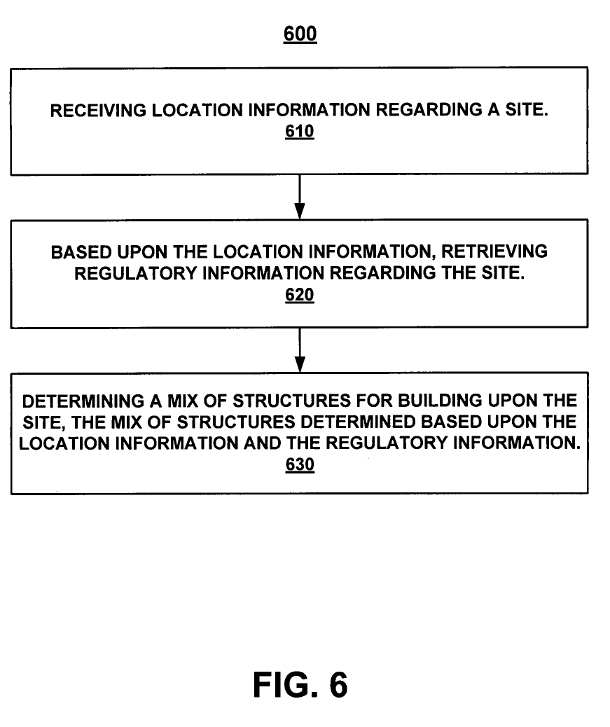

The above discussion has set forth in detail the operation of some example systems, devices, and methods of operation of embodiments described herein. With reference to FIGS. 6, 9, 12, and 13 and flow diagrams 600, 900, 1200, and 1300, example steps used by various embodiments of the present technology have been illustrated. Flow diagrams 600, 900, 1200, and 1300 describe methods that, in various embodiments, are carried out by a processor under the control of computer-readable and computer-executable instructions. Thus, in some embodiments, these methods are implemented via a computer, such as computer system 100 of FIG. 1. The computer-readable and computer-executable instructions reside, for example, in data storage features such as computer usable/readable volatile memory 104, computer usable/readable non-volatile memory 106, or computer useable/readable storage device 118 of computer system 100 (all shown in FIG. 1). The computer-readable and computer-executable instructions, which may reside on computer useable/readable media, are used to control or operate in conjunction with, for example, processor 102 of FIG. 1. Although specific steps are disclosed in flow diagrams 600, 900, 1200, and 1300, such steps are examples. That is, embodiments are well suited to performing various other steps or variations of the steps recited. It is appreciated that the steps in flow diagrams 600, 900, 1200, and 1300 may be performed in an order different than presented, and that not all of the steps in flow diagrams 600, 900, 1200, and 1300 may be performed.

### Determining a Development Mix for a Site

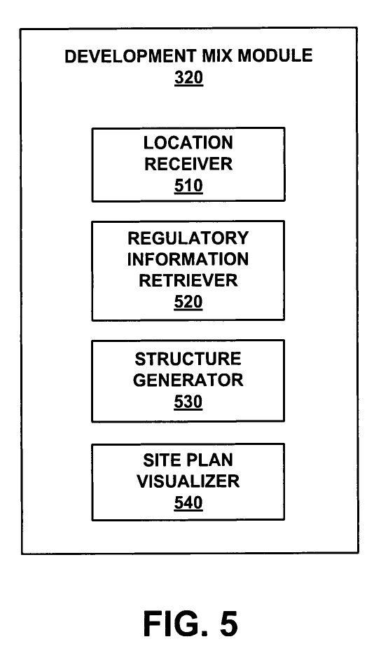

FIG. 5 illustrates a block diagram of development mix module 320. As shown in FIG. 5, development mix module 320 is comprised of a location receiver 510, a regulatory information retriever 520, a structure generator 530, and a site plan visualizer 540.

Location receiver 510 receives location information which identifies the location of a site. In one embodiment, location receiver 510 operates in conjunction with user interface module 310 to receive location information regarding a site.

Regulatory information retriever 520 uses the location of the site to automatically retrieve regulatory information regarding the site, such as, for example, local, county, state, or national regulations regarding a site. Zoning information and environmental information are two examples of such regulatory information. Such regulatory information may be retrieved by regulatory information retriever 520 from storage within site development planning data module 350, and/or retrieved from site development planning data sources 360 via site development planning data module 350.

Structure generator 530 utilizes the retrieved regulatory information and site location information (e.g., to determine the available area on a site) to generate a list of one or more suitable structures and their locations with respect to the site. This list of structures forms the basis of a development mix for the site. Structure generator 530 also performs clash detection in response to manipulation of a site visualization plan.

Site plan visualizer 540 arranges the structures of the development mix into a viewable site plan visualization, such as a plan view of the development mix for the site. In one embodiment development mix module 320 outputs the site plan visualization and/or the development mix for display to a user to view and/or manipulate or for other use, such as for follow-on site development planning.

FIG. 6 illustrates a flow diagram 600 of an example method for determining a development mix for a site, in accordance with one embodiment. The operation of the method of flow diagram 600 is described with reference to components and functionality of site development planner 300 and development mix module 320.

At 610 of flow diagram 600, in one embodiment, the method receives location information regarding a site. The location information can be received in any of a variety of spatially descriptive formats, such as: a legal description of the site (e.g., metes and bounds format, federal township and range format, or other legal land description format); surveyed boundaries; latitude and longitude coordinates of the site; geospatial data of the site; lot number in planned development (e.g., a particular lot in a sub-division plan); and street address. In one embodiment, location receiver 510 receives such location information regarding a site from a user entry or selection of such information via user interface, such as via location input region 410 of user interface 400.

At 620 of flow diagram 600, in one embodiment, the method automatically retrieves regulatory information regarding the site. This automatic retrieval is based upon the location information. Thus, for example, in an embodiment where the location information indicates that site 200 is located in San Jose, Calif., regulatory information retriever 520 searches out and retrieves regulatory information for the Country of the United States of America, State of California, County of Santa Clara, and/or City of San Jose.

This comprises automatically retrieving zoning information regarding the location of the site (e.g., types/uses of structures a site is zoned for, square footage limitations of structures, structure separation requirements, set-back requirements, and the like). This can also include automatically retrieving information such as environmental information (e.g., information regarding an endangered or protected species known to be located on the site); building code information regarding the site (e.g., earthquake hardening requirements, signage limitations, building height limitations, and parking space requirements, green space requirements); American's with Disabilities Act (ADA) requirements; and other similar regulatory information. Regulatory information retriever 520 accesses such regulatory information via site development planning data module 350, which may maintain such information or reach out to network accessible site development planning data sources 360.

At 630 of flow diagram 600, in one embodiment, the method determines a mix of structures for building upon the site. The mix of structures, otherwise known as a development mix, is determined based upon the location information and the regulatory information. In one embodiment, this structure generator 530 determines mix of structures for a site.

Consider an example where site 200 is zoned for commercial and retail development. By exclusion, the type of structures which may be placed on a site 200 is limited to commercial and retail structures, and thus structure generator 530 includes no residential or industrial structures in the development mix that is determined for site 200. In one embodiment, for instance, by referencing set back requirements (set-back from a road or property boundary), parking space requirements, square footage limitations, and building separation requirements, structure generator 530 determines the maximum square footage of space which can be built out on the site. Structure generator 530 then locates footprints of a parking lot and a variety of commercial and retail structures on the site in a manner that complies with the retrieved regulatory information for the site, while simultaneously attempting to achieve, or get as close as possible to, the square footage of the maximum build out calculated for the site.

In some instances, for example, structure generator 530 iteratively places footprints, such as from a library of standard structures footprints until an optimum or threshold (e.g., 90%) solution is achieved in light of the retrieved regulatory information. It is appreciated that such a footprint may be associated with single story or multi-story structures, depending upon limitations imposed by retrieved regulatory information and/or constraints selected by a user. For example, structures may be limited to a single story by a regulatory height limitation or due to insufficiency of parking space to support regulatory requirements of parking space for the square footage and number of tenants associated with multistory structures.

The solution achieved by structure generator 530 becomes the development mix for the site. Thus for example, in one embodiment, a development mix for site 200 comprises four commercial buildings and two retail buildings arranged around a central parking lot. In one embodiment, this development mix is provided as an output by development mix module 320. For example, in some embodiments development mix module 320 displays the development mix in display region 450 of user interface 400. In some embodiments, the development mix is provided for use by other modules of site development planner 300.

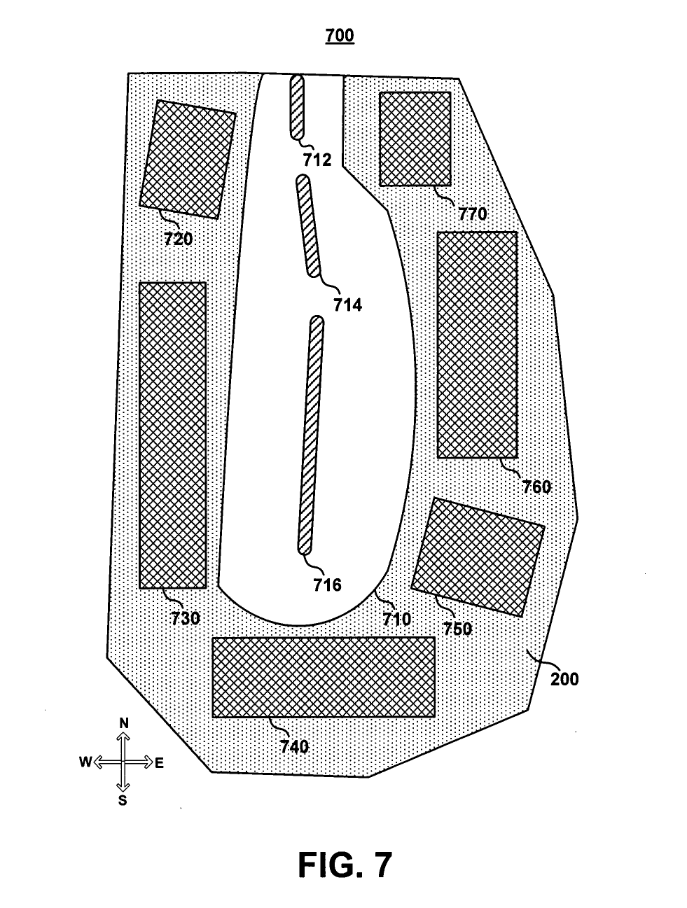

In one embodiment, the method of flow diagram 600 also automatically generates a site plan visualization for the site. For example, with reference to user interface 400, the site plan visualization is automatically generated in response to a user selecting the “VISUALIZATION” option in the development mix region 420 of user interface 400. The site plan visualization is based upon the location information of the site and the mix of structures as defined by the development mix. The site plan visualization may comprise a plan view, perspective view, elevation view, and/or three-dimensional view of the development mix that has been determined for the site. One example of a site plan visualization is shown in FIG. 7.

With reference to FIG. 7, a site plan visualization 700 of a development mix for site 200 is shown. The development mix of the previous example is shown in site plan visualization 700. As shown, example site plan visualization 700 represents a plan view of two retail structures (720 and 770) and four commercial structures (730, 740, 750, and 760). As an example of how retrieved regulatory requirements are incorporated by structure generator 530, the structures (720-770) are arranged around a central parking lot 710 which has been sized to provide adequate standard parking and disabled accessible parking, in accordance with retrieved regulatory requirements, for the sizes and types of structures (720-770) that have been located on site 200. Additionally, the structures are located such that they are separated from one another and set-back from roads and site boundaries to comply at least with minimum separation and set-back distances proscribed by retrieved regulatory requirements applicable to site 200. Further, parking lot 710 is comprised of three parking islands (712, 714, and 716), which provide parking lot green space as required by retrieved regulations applicable to site 200. In one embodiment, site plan visualization 700 is displayed for viewing and/or manipulation by a user, for example, in display region 450 of user interface 400.

In one embodiment, the method of flow diagram 600 also comprises receiving a user input regarding a desired development type for a site. For example, with reference to user interface 400, in response to a user selecting “CONSTRAINTS” in the development mix region 420 a user is presented with a selectable list of development constraints to apply to structures selected by structure generator 530. Consider an example embodiment where a site 200 is zoned for commercial and retail development, a user is presented with options which allow imposition of development constraints over the mix of structures that structure generator 530 includes in the development mix (e.g., strictly retail, strictly commercial, or a mix of retail and commercial structures). Structure generator 530 then uses the user's selection of the desired development type as a development constraint in determining the mix of structures for building on site 200. Likewise, in some embodiments, a user is allowed to select development constraints such as the maximum square footage of any structure, the maximum and/or minimum number of structures for a site, the number and type of tenants desired, and the number of stories allowed for structures. For example, a user may input, as a constraint, that he desires the site to be developed with space for thirty commercial tenants and four retail tenants. Structure generator 530 then employs such development constraints to guide selection of structures during generation of the development mix.

When site visualization plan 700 is displayed in display region 450, a user may manipulate positions, orientations, and sizes of structures 720-770 or other features displayed in site visualization plan 700 through the use of cursor 460 and a cursor control 116 such as a mouse. This manipulation of features of site visualization plan 700 is similar in operation to the manipulation of elements of a Computer Aided Drafting file. For example, a user may select structure 740 with cursor 460 and then reposition or rotate structure 740 to improve solar orientation characteristics of structure 740 or to improve the aesthetic layout of site visualization plan 700. Likewise, a user may similarly select structure 730 and then increase the size of structure 730 or select parking lot 710 and then decrease the size or parking lot 710.

In response to such manipulation or “tweaking” of site visualization plan 700, structure generator 530 performs clash detection based upon the rules and guidelines which were used to generate the structures and locations of structures of site visualization plan 700. As part of clash detection, a user may be prohibited from performing a manipulation and/or presented with a notification. Prohibiting site plan manipulation and/or providing notification in response to a clash caused by a user manipulation allows a user to quickly ascertain a potential impact of the manipulation upon the cost, schedule, occupancy load, and/or use for structures of a site.

Consider an example where a user has increased the size of structure 730 such that it now has a one meter set back from the curb of parking lot 710. Structure generator 530 may be prevent the user from making the change if it clashes with a local regulation which requires a minimum set back distance of three meters. Additionally or alternatively, site plan visualizer 540 may present a notification of the clash. For instance, a dialog box may be presented in display region 450 with text such as: “Notice: San Jose City Code 2007-00123 requires a structure to be set back from a curb by a minimum distance of three meters.”

Consider another example in which the user has shrunk the size of the parking lot such that it is only sufficiently sized for 75 standard parking spaces and 4 disabled accessible parking spaces. Structure generator 530 may prevent the user from making the change if it clashes with a regulation which requires 75 standard sized parking spaces and 7 disabled accessible parking spaces based upon the square footage, estimated occupancy, or desired use of structures 720-770. Additionally or alternatively, site plan visualizer 540 may present the user with a notification of the clash. For instance, a dialog box may be presented in display region 450 with text such as: “Notice: California Code of Regulations, Title 24, Part 2 requires that ten percent of all parking spaces be allocated as disabled accessible spaces if a structure is designated for medical use.”

### Estimating a Site Earthworks Parameter

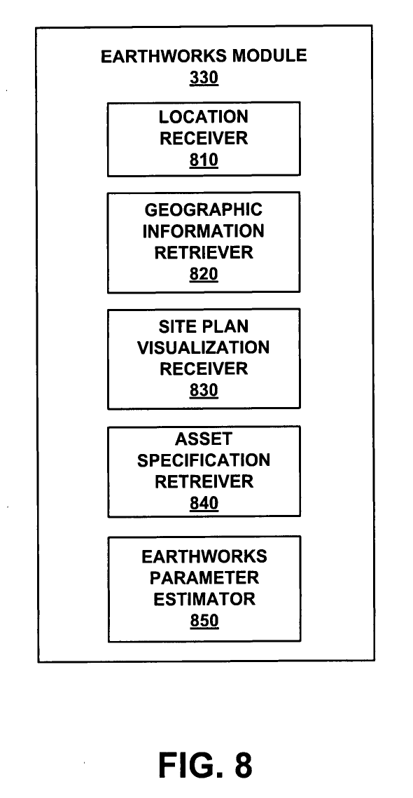

FIG. 8 illustrates a block diagram of earthworks module 330. As shown in FIG. 8, earthworks module 330 is comprised of a location receiver 810, a geographic information retriever 820, a site plan visualization receiver 830, an asset specification retriever 840, and an earthworks parameter estimator 850.

Location receiver 810 receives location information which identifies the location of a site. In one embodiment, location receiver 810 operates in conjunction with user interface module 310 to receive location information regarding a site.

Geographic information retriever 820 uses the location of the site to automatically retrieve geographic information regarding the site. Some examples of geographic information include elevation information, water runoff information, and soil condition information (e.g., a description of the geological types of earth expected at the site). Such geographic information may be retrieved by geographic information retriever 820 from storage within site development planning data module 350, and/or retrieved from site development planning data sources 360 via site development planning data module 350. It is appreciated that a user may direct that geographic information regarding the site be retrieved from a specific file or network accessible source. For example, such geographic information may be retrieved from a geographical survey file or report. Additionally a user may provide geographical information regarding the site, for instance as a constraint, if such information is known to the user.

Site plan visualization receiver 830 receives a site plan visualization, such as site plan visualization 700. The site plan visualization is received from development mix module 320 or some other source, such as being specified by a user.

Asset specification retriever 840 retrieves one or more asset specifications for one or more earthmoving assets. Such asset specifications may be retrieved for a default list (mix) of earthmoving assets or for a user specified list (mix) of earth moving assets. Such asset specification information may be retrieved by asset specification retriever 840 from storage within site development planning data module 350, and/or retrieved from site development planning data sources 360 via site development planning data module 350. Asset manufacturer and asset rental websites and databases are examples of site planning data sources 360 from which such asset specification information may be retrieved. Asset specifications include capacity, cost, efficiency, and capability specifications for earthmoving assets. Some specific examples of asset specifications include: the number of cubic yards of earth an earthmoving asset can remove in one load or in time period (e.g., one hour), the cost for renting an earthmoving asset for a period of time, and/or the cost of operating an earthmoving asset for a period of time.

Earthworks parameter estimator 850 utilizes the retrieved geographic information, the received site plan visualization, and one or more asset specifications to determine an earthworks parameter for the development mix of the site plan visualization. An estimate of how much earth will need to be cut or filled to prepare the site is one example of an earthworks parameter estimated by earthworks parameter estimator 850. An estimate of the length of time it will take to perform earthworks for the site is another example of an earthworks parameter estimated by earthworks parameter estimator 850. An estimate of the number of personnel it will take to perform earthworks for the site is another example of an earthworks parameter estimated by earthworks parameter estimator 850. It is appreciated that the estimates of the time, personnel, and types of equipment may be based upon multiple factors, such as the volume of cut and fill required, the soil conditions for the site, and a user's desired completion time and/or budget. For example, a different equipment mix estimate may be provided for a site which will only require excavation of sandy soil than for a site which will require excavation of rocky soil. Likewise, a longer preparation time may be estimated for a site with rocky soil than for a site with sandy soil. Moreover, an estimate of equipment and/or personnel may be specified in order to meet a earthworks budget or completion time which has been provided as a constraint. In one embodiment earthworks module 330 outputs the earthworks parameter for display to a user or for other use, such as for follow-on site development planning.

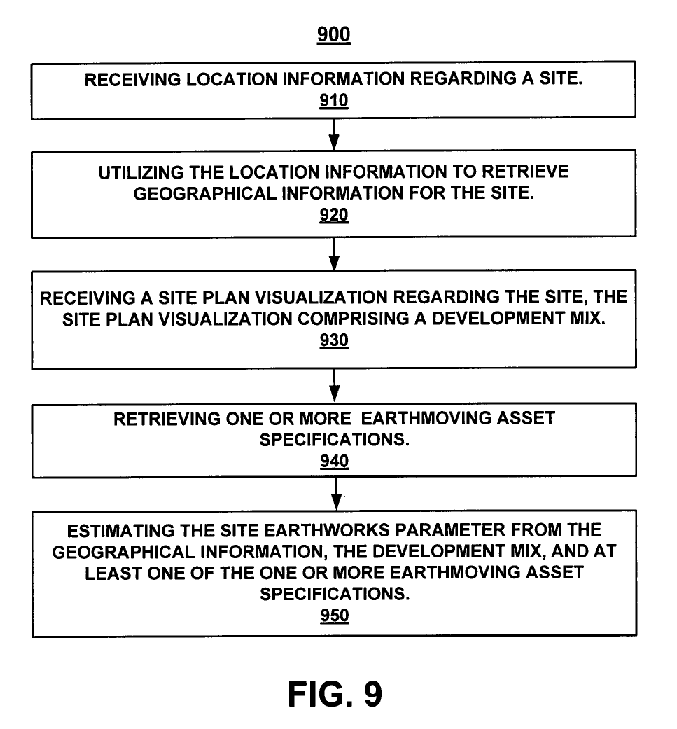

FIG. 9 illustrates a flow diagram 900 of an example method for determining at earthworks parameter for a site, in accordance with one embodiment. The operation of the method of flow diagram 900 is described with reference to components and functionality of site development planner 300 and earthworks module 330.

At 910 of flow diagram 900, in one embodiment, the method receives location information regarding a site. The location information can be received in any of a variety of spatially descriptive formats, such as: a legal description of the site (e.g., metes and bounds format, federal township and range format, or other legal land description format); surveyed boundaries; latitude and longitude coordinates of the site; geospatial data of the site; lot number in planned development (e.g., a particular lot in a sub-division plan); and street address. In one embodiment, location receiver 810 receives such location information regarding a site from a user entry or selection of such information via a user interface, such as via location input region 410 of user interface 400.

At 920 of flow diagram 900, in one embodiment, the method automatically retrieves geographical information regarding the site. This automatic retrieval is based upon the location information. Consider an example where the received location information indicates that site 200 is located in zip code 95110 of San Jose, Calif.: In one embodiment, geographic information retriever 820 searches out and retrieves geographic information regarding the portion of San Jose, Calif. and specifically the portion of the city covered by zip code 95110. Likewise, in other embodiments, such geographic information is also retrieved based upon other forms of location information such as coordinates, boundaries, legal descriptions, or lot numbers.

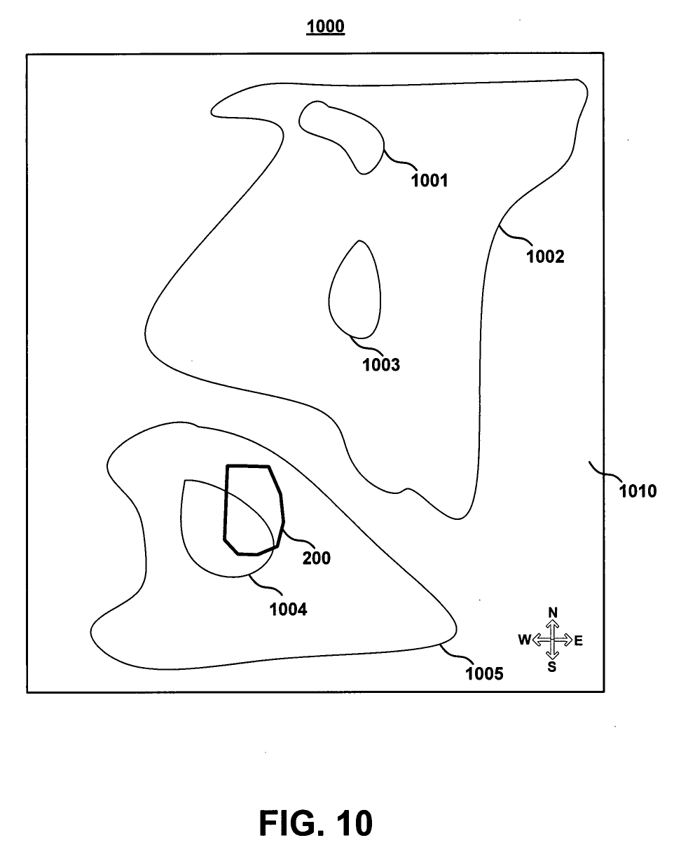

In an embodiment, geographic information retriever 820 automatically retrieves geographic information regarding the site, such as: topographical information (e.g., elevation changes of the site), water runoff or watershed information for a site; and/or soil conditions regarding a site. Geographic information retriever 820 accesses and retrieves such geographic information via site development planning data module 350, which may maintain such information or reach out to network accessible site development planning data sources 360. FIG. 10 shows one example of topographical information retrieved for a site based upon location information of the site.

FIG. 10 shows an example topographical map 1000 which has been automatically retrieved for site 200, in accordance with one embodiment. Contour lines 1001, 1002, 1003, 1004, and 1005 indicate elevation changes relative to one another and relative to region 1010 of topographical map 1000. The footprint of site 200 is shown overlaid upon topographical map 1000. Based upon the location of the footprint of site 200 with respect to topographical map 1000, the elevation changes of site 200 are determinable from contour lines 1004 and 1005, which cross or encompass the parcel of land which comprises site 200.

At 930 of flow diagram 900, in one embodiment, the method receives a site plan visualization regarding the site. The site plan visualization comprises a development mix for the site. In one instance site plan visualization receiver 830 receives this site plan visualization from development mix module 320 or from some other source (e.g., a user provided site plan visualization). Utilizing site 200 as an example, in one embodiment, this comprises site plan visualization receiver 830 receiving site plan visualization 700, either from development mix module 320 or from some other source.

At 940 of flow diagram 900, in one embodiment, one or more earthmoving asset specifications are automatically retrieved. This comprises asset specification retriever 840 retrieving one or more specifications for one or more earthmoving assets, such as: scrapers, dozers, backhoes, compactors, graders, dump trucks, and the like, which are typically employed to perform earthworks operations. The earthworks asset specifications may be retrieved for a default mix of earthmoving assets or for a user specified mix of earthmoving assets. For example, in one embodiment, by selecting “EQUIPMENT MIX” in earthworks region 430 of user interface 400, a user is presented with selectable options for determining a mix of earthworks assets to utilize in performing earthworks for a site. Some examples of a user specified mix of earthworks assets include a list of earthworks assets that a user owns, is able to rent, or has personnel qualified to operate. Asset specification retriever 840 then automatically retrieves asset specifications for the user specified equipment mix of earthworks assets.

At 950 of flow diagram 900, in one embodiment, a site earthworks parameter is estimated from the geographical information, the development mix, and at least one earthmoving asset specification. Such earthworks parameter estimates are performed by earthworks parameter estimator 850, either automatically or in response to a user selection of an option via a user interface. In one embodiment, for example, earthworks parameter estimator 850 estimates a time for completing earthworks for a site in response to a user selection of the “TIME ESTIMATE” option in earthworks region 430 of user interface 400. Likewise, in one embodiment, earthworks parameter estimator 850 estimates a cost for completing the earthworks for a site in response to a user selection of the “COST ESTIMATE” option shown earthworks region 430 of user interface 400.

For example, by determining the foundation requirements (the volume and depth of foundations) and grade requirements from the site plan visualization and information regarding elevations on the site, earthworks parameter estimator 850 estimates an earthworks parameter such as the number of cubic yards of earth that need to be cut and/or filled on the site. Utilizing information regarding cubic yards of earth which need to be cut and/of filled on the site and one or more asset specifications of a default or user specified equipment mix, earthworks parameter estimator 850 estimates earthworks parameters such as the length of time required to perform the earthworks; the cost to perform the earthworks; the number of man-hours needed to perform the earthworks; and a list (mix) of earthworks assets needed to perform the earthworks for the site. Such earthworks parameter estimates may be conditioned upon the use of a default set of earthworks constraints; a user defined set of earthworks constraints; or a set of earthworks constraints selected by earthworks parameter estimator 850 (such as through iterative calculations) to minimize the earthworks parameter being estimated.

As an example of such iterative calculations, in one embodiment, earthworks parameter estimator 850 makes a comparison between earthworks which need to be performed and capabilities of a variety of permutations of a user specified or default earthworks asset mix. Through such a comparison earthworks parameter estimator 850 estimates an earthworks asset mix for performing the earthworks. Such an asset mix may be predicated upon completing the earthworks for the lowest cost, completing the earthworks with a minimum number of earthworks assets, completing the earthworks as fast as possible, or balancing the speed of completion with the cost of completing the earthworks.

In one embodiment, the method of flow diagram 900 also comprises receiving a user specified earthworks constraint regarding performance of earthworks for the site. Such a user specified earthworks constraint is then utilized in conjunction with the retrieved geographical information, development mix, and one or more retrieved earthmoving asset specifications to estimate or refine estimates of earthworks parameters. In one embodiment a user specified earthworks constraint is received, for example, via a user interface. For example, with reference to user interface 400, in one embodiment, in response to a user selection “CONSTRAINTS” in earthworks region 430, a user is provided with a selectable list of constraints such as earthmoving asset mix constraints (e.g., utilize a minimum number of assets from an asset mix to perform earthworks for a site), an earthworks schedule constraint (e.g., complete earthworks as fast as possible or complete earthworks within a specified period of time, such as 20 days), an earthworks personnel constraint (e.g., complete earthworks utilizing a minimum number of man-hours, a minimum number of personnel, or a particular number of personnel), and an earthworks cost constraint (e.g., complete earthworks for a minimum cost or complete earthworks for less than a particular cost).

### Determining a Site Build Phase Parameter

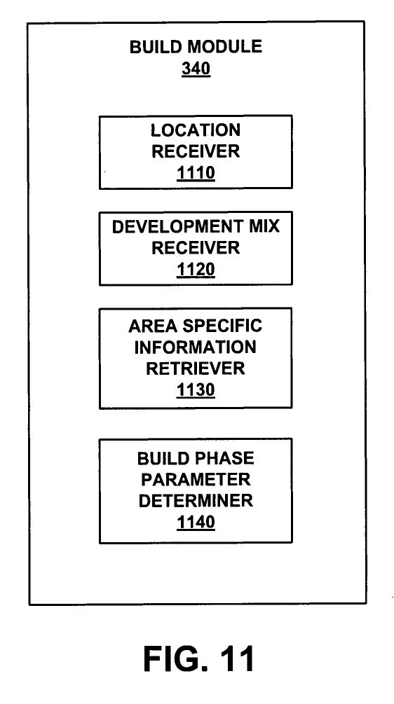

FIG. 11 illustrates a block diagram of build module 340. As shown in FIG. 11, build module 340 is comprised of a location receiver 1110, a development mix receiver 1120, an area specific information retriever 1130, and a build parameter determiner 1140.

Location receiver 1110 receives location information which identifies the location of a site. In one embodiment, location receiver 1110 operates in conjunction with user interface module 310 to receive location information regarding a site.

Development mix receiver 1120 receives a development mix, such as a development mix that is used to create a site plan visualization. The development mix is received from development mix module 320 or some other source, such as being specified by a user.

Area specific information retriever 1130 automatically retrieves area specific performance information for performing building and/or construction upon a site for which development planning is being conducted. Based upon the location information, such area specific performance information is accessed by area specific information retriever 1130 from storage within site development planning data module 350, and/or retrieved from site development planning data sources 360 via site development planning data module 350.

Some examples of area specific performance information which may be retrieved include: area specific rental rates for structures included in the development mix (e.g., prevailing rental cost per square foot of retail space, commercial space, industrial space, residential space); area specific prevailing wages for construction specialties needed to build structures of the development mix; area specific construction timeline information pertaining to structures of the type specified in the development mix; area specific construction costs information for the structures of the development mix (e.g., an average/prevailing cost per square foot to build a retail structure in a particular area); area specific occupancy rates related to types of structures in the development mix; area specific traffic pattern information (e.g., results of traffic studies performed near the site); prevailing interest rates for construction loans (e.g., one or more bank websites or nationwide or area specific databases regarding loan interest rates may be accessed); and area specific building permit information related to the types of structures in the development mix (e.g., information on the permitting process related to the location of a site, building permits required in at a site for building types of structures of a development mix, and authorities which issue building permits for a site).

Build phase parameter determiner 1140 determines a build phase parameter for the development mix based upon one or more elements of area specific performance information. Some examples of build phase parameters which may be determined include: income streams, build sequence, total construction cost, and timeline for completion.

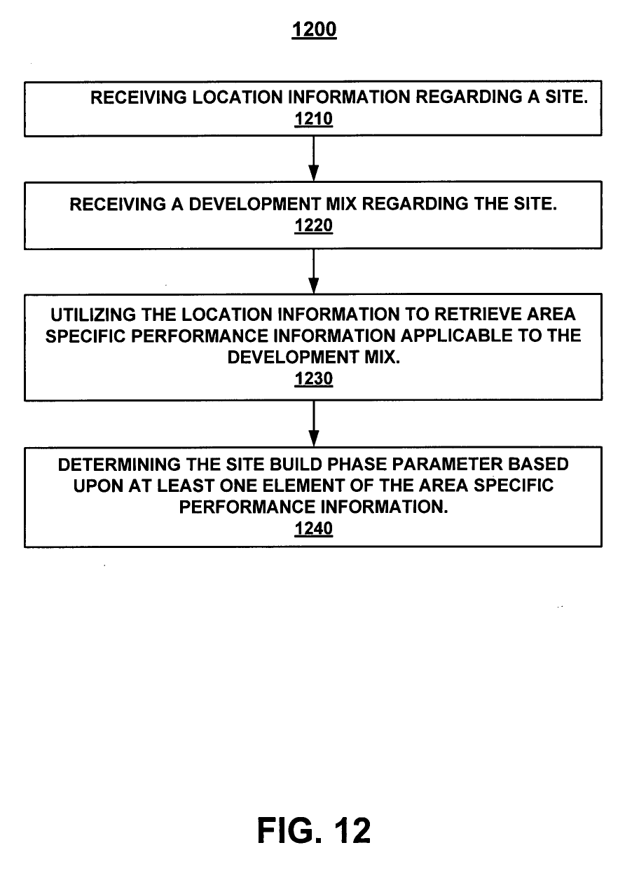

FIG. 12 illustrates a flow diagram 1200 of an example method for determining a site build phase parameter, in accordance with one embodiment. The operation of the method of flow diagram 1200 is described with reference to components and functionality of site development planner 300 and build module 340.

At 1210 of flow diagram 900, in one embodiment, the method receives location information regarding a site. The location information can be received in any of a variety of spatially descriptive formats, such as: a legal description of the site (e.g., metes and bounds format, federal township and range format, or other legal land description format); surveyed boundaries; latitude and longitude coordinates of the site; geospatial data of the site; lot number in planned development (e.g., a particular lot in a sub-division plan); and street address. In one embodiment, location receiver 1110 receives such location information regarding a site from a user entry or selection of such information via a user interface, such as via location input region 410 of user interface 400.

At 1220 of flow diagram 1200, in one embodiment, the method receives a development mix regarding the site. In one instance development mix receiver 1120 receives the development mix from development mix module 320 or from some other source (e.g., a user provided development mix for a site). Utilizing site 200 as an example, in one embodiment, this comprises site plan visualization receiver 830 receiving the development mix associated with site plan visualization 700, either from development mix module 320 or from some other source.

At 1230 of flow diagram 1200, in one embodiment, the method utilizes the location information to retrieve area specific performance information applicable to the development mix. In an embodiment, this comprises area specific information retriever 1130 automatically retrieving area specific performance information for the site (e.g. site 200) based upon the location of the site. In one embodiment, area specific information retriever 1130 retrieves this information upon a user initiation of the retrieval, such as, for example, when a user selects a selectable option in build region 440 of user interface 400. Area specific performance information comprises build information that is specific to performance of building structures in the local area of the site for which development planning is being performed. Some examples include the city, county, or state in which a site is located. Based upon the location information, such area specific performance information is accessed and retrieved by area specific information retriever 1130 from storage within site development planning data module 350, and/or retrieved from site development planning data sources 360 via site development planning data module 350.

At 1240 of flow diagram 1200, in one embodiment, the method determines one or more site build phase parameters based upon at least one element of the area specific performance information which has been accessed. It is appreciated that such site build phase parameter(s) may be determined automatically. In one embodiment, build phase parameter determiner 1140 determines such build phase parameter(s).

As an example, in one embodiment, build phase parameter determiner 1140 parses building permit information related the specific area of a site, such as site 200. By parsing this building information with respect to the type of structures that are in a development mix for the site, build phase parameter determiner 1140 locates, and then provides to a user building permit information related to a development mix which is being planned for the site. Build phase parameter determiner 1140 retrieves and outputs such building permit information automatically or else in response to a user input, such as, for example, a user selecting the “BUILDING PERMITS” option in build region 440 of user interface 400.

Consider a specific example centered on site plan visualization 700 of FIG. 7. In one embodiment, build phase parameter determiner 1140 locates and provides building permit information related to one or more of the structures (720-770) of the development mix upon which site plan visualization is based. For example, in one embodiment, building permit information for retail structure 720 is located. This building permit information indicates that 90 days prior to commencement of building a retail structure, a permit must be applied for in person at the San Jose City Hall, located at 200 East Santa Clara Street, San Jose, Calif. 95113. In one instance, build phase parameter determiner 1140 outputs this building permit information regarding structure 720 for use by a user, such as in display region 450 of user interface 400 (FIG. 4).

As another example, in one embodiment, build phase parameter determiner 1140 compares structure types and square footage of structures on a site with information regarding average construction costs for the area in which the site is located. As a result of this comparison, build phase parameter determiner 1140 estimates a total cost to construct all structures or individual structures of the development mix. Build phase parameter determiner 1140 determines such a cost estimate either automatically or in response to a user input, such as, for example, a user selecting the “COST ESTIMATE” option in build region 440 of user interface 400.

Consider a specific example where structure 720 of site plan visualization 700 is a retail structure of 3,000 square feet. Using area specific performance information which indicates an average build cost of $95 per square foot for retail structures, build phase parameter determiner 1140 estimates a construction cost of, for example, $285,000 to build structure 720. Similarly, build phase parameter determiner 1140 may perform such construction cost estimates for each structure of a site, and then calculate a total cost of construction for the development mix upon which site plan visualization 700 is based.

As another example, in one embodiment, build phase parameter determiner 1140 compares area specific information regarding average construction times of structures for the area in which a site is located with structure types and square footage of structures on the site. As a result of this comparison, build phase parameter determiner 1140 estimates a timeline for constructing all structures or individual structures of the development mix. Such a timeline estimate may be determined automatically, or determined in response to a user input, such as a user selecting the “TIME ESTIMATE” option in build region 440 of user interface 400.

Consider a specific example where structure 720 of site plan visualization 700 is a retail structure of 3000 square feet. Using area specific performance information which indicates that several similar structure were built in an average of 16 weeks, build phase parameter determiner 1140 estimates a construction timeline of, for example, 16 weeks to build structure 720. Similarly, build phase parameter determiner 1140 may perform such construction timeline estimates for each structure of a site, and then calculate a construction time estimate for the development mix upon which site plan visualization 700 is based. It is appreciated that such construction timeline information may be retrieved by area specific information retriever 1130 or supplied as a user input. For example, by choosing a selectable option such as “CONSTRAINTS” in build region 440 of user interface 400, a user is presented with a dialog box or other input mechanism which allows a build phase constraint such as a construction timeline to be selected or input.

In another example, in one embodiment, build phase parameter determiner 1140 compares area specific rental rates for the area in which a site is located with structure types and structure square footage values from the development mix. As a result of this comparison, build phase parameter determiner 1140 estimates a rental income for all or individual structures of a development mix. Such an income estimate may be determined automatically, or determined in response to a user input, such as a user selecting the “INCOME ESTIMATE” option in build region 440 of user interface 400.

Consider a specific example where structure 730 of site plan visualization 700 is a commercial structure of 10,000 square feet. Using area specific performance information which indicates an average rental rate of $1.50 per square foot for commercial structures, build phase parameter determiner 1140 estimates monthly rental income of, for example, $15,000 for structure 730. Such a rental income estimate can be on a monthly or yearly basis, or for some other term. Likewise, such rental income estimates may be adjusted for inflation converted into a net present value. It is appreciated that in a similar manner, income estimates can be provided based upon area specific sales prices for particular structure types.

In one embodiment, build phase parameter determiner 1140 uses area specific occupancy information is used to adjust an income estimate. Such occupancy information may accessed by area specific information retriever 1130, or else provide by a user. For example, by choosing a selectable option such as “CONSTRAINTS” in build region 440 of user interface 400, a user is presented with a dialog box or other input mechanism which allows a build phase constraint such as a user estimated occupancy rate to be selected or input. Thus, for example, if area specific occupancy information indicates that commercial structures are presently 80% occupied by tenants, build phase parameter determiner 1140 adjusts the estimate of rental income for structure 730 to $12,000 per month. Similarly, build phase parameter determiner 1140 may perform such estimates for each structure of a site, and then calculate an occupancy adjusted total estimated rental income for the development mix upon which site plan visualization 700 is based.

In one embodiment, build phase parameter determiner 1140 estimates a net present value of the income streams (e.g., rental or sales income) of structures of a development mix based upon a build sequence. The build sequence may be randomly selected, user selected, or iteratively selected (e.g., a variety or all build sequences for a development mix are evaluated). In one embodiment, a build sequence is selected to maximize cash flow during the building of structures of a site visualization plan.

Consider an example, where build phase parameter determiner 1140 estimates the rental incomes for every possible build sequence of the structures (720-770) of site plan visualization 700, while simultaneously taking into account time estimates of how long it will take to build each structure (720-770). In one embodiment, build phase parameter determiner 1140 then converts the estimated income stream for each possible build sequence into a net present value. One or more of these net present value income stream estimates can then be output to a user, such as in display region 450 of user interface 400.

In the construction industry, large projects are often partially financed by building one or more structures and then leveraging cash flow from these completed structures to finance building of additional structures. Thus, selecting a build sequence to optimize cash flow is an important planning consideration that often extracts substantial time and energy from a developer. By advantageously choosing a build sequence which will maximize the cash flow, extra cash flow above and beyond that required for paying interest on borrowed money and/or paying for construction expenses may be retained as profit.

Consider another example, in which build phase parameter determiner 1140 has estimated rental incomes and/or sales prices for structures of a site visualization plan 700. A user may additionally provide as a constraint a term or terms (e.g., principal, interest, time, monthly payment) of a construction loan or financing instrument being used or considered for use in financing development of the structures of site visualization plan 700. The user may also provide a required or desired cash flow as an input constraint. For example, the user may provide a minimum cash flow that is needed in order to finance on going construction. Based upon such inputs and upon other inputs such as a prevailing or user specified interest rate, estimates of rental incomes/and or sales prices of structures in site visualization plan 700, and estimated or user provided timelines for the building the structures (720-770) of site visualization plan 700, build phase parameter determiner 1140 determines a build sequence for the structures (720-770) which will maximize cash flow. The determined build sequence and estimated cash flow are provided as outputs from build phase determiner 1140. It is appreciated that such a build sequence determination may be carried out automatically or determined in response to a user input, such as a user selecting the “BUILD SEQUENCE” option in build region 440 of user interface 400.

In one embodiment, a user is allowed to input a build sequence or modify a determined build sequence (such as through the use of the “BUILD SEQUENCE” option in build region 440 of user interface 400). In response to such user input or modification, an estimated cash flow is provided as an output from build phase parameter determiner 1140. A user such as a developer may utilize such estimates of the cash flows generated by a variety of build sequences to choose a build sequence or to evaluate the profitability associated with developing a particular site.

Moreover, in one embodiment, build phase parameter determiner 1140 compares all of the estimated net present values income streams for the evaluated build sequences, and selects the build sequence which provides the highest estimated net present value income stream as a preferred build sequence, for the development mix upon which site plan visualization 700 is based. Such a build sequence determination may be carried out automatically, or determined in response to a user input, such as a user selecting the “BUILD SEQUENCE” option in build region 440 of user interface 400.

### Method of Site Development Planning

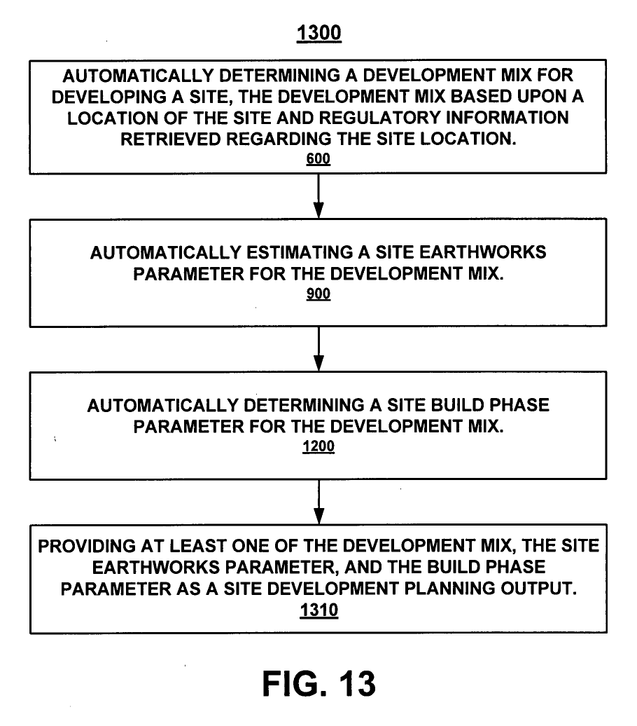

FIG. 13 illustrates a flow diagram 1300 of an example method for site development planning, in accordance with one embodiment. The operation of the method of flow diagram 1300 is described with reference to flow diagrams 600, 900 and 1200 and components and functionality of site development planner 300. It is appreciated that in one embodiment, the method for site development planning may be offered as a service to a user. For example, a user at a remote location may input information which is sent to a network connected location where the site development planning is performed based upon the input information. The results of the site development planning are then sent back to the user, as an output from the network connected location. It is appreciated that a fee may be charged for such a service.

At 600 of flow diagram 1300, in one embodiment, the method automatically determines a development mix for developing a site. The development mix is based upon a location of the site and regulatory information retrieved regarding the site location. The regulatory information is retrieved automatically based upon user provided location information regarding the location of the site. This automatic determination is triggered in one embodiment, in response one or more inputs or selections provided by a user, such as through a user interface. User interface 400 (FIG. 4) is one example of such a user interface. The process for such determining of a development mix is carried out, for example by evaluating information using a computer system such as computer system 100 of FIG. 1. The determination of a development mix for developing a site has been previously described in conjunction with flow diagram 600 of FIG. 6, and for purposes of brevity and clarity will not be repeated again herein.

At 900 of flow diagram 1300, in one embodiment, the method automatically estimates one or more site earthworks parameters for the development mix determined in 600 of flow diagram 1300. This automatic estimation of one or more site earthworks parameters is triggered, in one embodiment, in response one or more inputs or selections provided by a user, such as through a user interface. User interface 400 (FIG. 4) is one example of such a user interface. The process for such determining of an earthworks parameter is carried out, for example by evaluating information using a computer system such as computer system 100 of FIG. 1. The determination of one or more site earthworks parameters has been previously described in conjunction with flow diagram 900 of FIG. 9, and for purposes of brevity and clarity will not be repeated again herein.

At 1200 of flow diagram 1300, in one embodiment, the method automatically determines one or more site build phase parameters for the development mix determined in 600 of flow diagram 1300. This automatic determination of one or more site build phase parameters is triggered, in one embodiment, in response one or more inputs or selections provided by a user, such as through a user interface. User interface 400 (FIG. 4) is one example of such a user interface. The process for such determining of an earthworks parameter is carried out, for example by evaluating information using a computer system such as computer system 100 of FIG. 1. The determination of one or more site build phase parameters has been previously described in conjunction with flow diagram 1200 of FIG. 12, and for purposes of brevity and clarity will not be repeated again herein.

At 1310 of flow diagram 1300, in one embodiment, the method provides a site development planning output. The site development planning output is comprised of one or more of the development mix, the earthworks parameter(s), and the build phase parameter(s). Through the use of a computer system, such as computer system 100, site development planner 300 provides the site development planning output for display on a display device, printing on a printer, storage in a storage device, for electronic accessibly by another system (including, but not limited to, storing the output in a database, posting the output to a web page, sending the output to a file server, or coupling the output to an input of another system), and/or for electronic transmission (e.g., an electronic transmission from a first computer system to a second computer system via the Internet).

As an example, in one embodiment, a site development planning output is provided for user viewing on a display device such as display device 112 (FIG. 1). In one such embodiment, site development planner 300 displays the site development planning output in a user interface, such as in display region 450 of user interface 400. As another example, a site development planning output is provided such that it is accessible for use by another planning or modeling system. For example, this may include formatting the site development planning output into an electronic file format that is readable by a particular planning or modeling system. This may also include storing an electronic file in a location that is accessible by a particular or modeling system and/or sending the file to the particular planning or modeling system.

Embodiments of the present technology are thus described. While the present technology has been described in particular embodiments, it should be appreciated that the present technology should not be construed as limited by such embodiments, but rather construed according to the following claims.

We claim:

1. A computer-implemented method for site development planning, said method comprising:
automatically determining a development mix for developing a site, said development mix based upon a location of said site and regulatory information retrieved regarding said site location;
automatically estimating a site earthworks parameter for said development mix;
automatically determining a site build phase parameter for said development mix; and
providing said development mix, said site earthworks parameter, and said build phase parameter as a site development planning output.

2. The method as recited in claim 1, wherein said automatically determining a development mix for developing a site comprises:
automatically determining said development mix based upon a user supplied development constraint.

3. The method as recited in claim 1, wherein said automatically determining a development mix for developing a site further comprises:
automatically generating a site plan visualization for said site, said site plan visualization based upon said location information and said mix of structures.

4. The method as recited in claim 1, wherein said automatically estimating a site earthworks parameter for said development mix comprises:
automatically estimating said site earthworks parameter from geographical information regarding said site, said development mix, and at least one earthmoving asset specification.

5. The method as recited in claim 1, wherein said automatically estimating a site earthworks parameter for said development mix comprises:
automatically estimating a cost to perform earthworks for said site.

6. The method as recited in claim 1, wherein said automatically determining said site build phase parameter for said development mix comprises:
automatically determining an estimated total cost to construct structures of said development mix.

7. The method as recited in claim 1, wherein said automatically determining said site build phase parameter of for said development mix site comprises:
automatically determining an estimated net present value of a build sequence of structures of said development mix.

8. The method as recited in claim 1, wherein said automatically determining said site build phase parameter for said development mix comprises:
utilizing said location of said site to automatically retrieve area specific performance information applicable to said development mix; and
determining said site build phase parameter based upon at least one element of said area specific performance information.

9. The method as recited in claim 8, wherein said automatically determining said site build phase parameter for said development mix further comprises:
determining a net present value of income streams for a plurality of build sequences of structures of said development mix; and
selecting a build sequence from said plurality of build sequences such that a net present value of said income streams is maximized.

10. The method as recited in claim 1, wherein said automatically determining said site build phase parameter of for said development mix site comprises:
automatically determining an estimated cash flow of a build sequence of structures of said development mix.

11. A computer-readable medium having computer-executable instructions for performing a method for site development planning, said method comprising:
automatically determining a development mix for developing a site, said development mix based upon a location of said site and regulatory information retrieved regarding said site location;
automatically estimating a site earthworks parameter for said development mix;
automatically determining a site build phase parameter for said development mix; and
providing said development mix, said site earthworks parameter, and said build phase parameter as a site development planning output.

12. The computer-readable medium of claim 11, wherein said automatically determining a development mix for developing a site comprises computer-executable instructions for:
automatically determining said development mix based upon a user supplied development constraint.

13. The computer-readable medium of claim 11, wherein said automatically determining a development mix for developing a site further comprises computer-executable instructions for:
automatically generating a site plan visualization for said site, said site plan visualization based upon said location information and said mix of structures.

14. The computer-readable medium of claim 11, wherein said automatically estimating a site earthworks parameter for said development mix comprises computer-executable instructions for:
automatically estimating said site earthworks parameter from geographical information regarding said site, said development mix, and at least one earthmoving asset specification.

15. The computer-readable medium of claim 11, wherein said automatically estimating a site earthworks parameter for said development mix comprises computer-executable instructions for:
automatically estimating a cost to perform earthworks for said site.

16. The computer-readable medium of claim 11, wherein said automatically determining said site build phase parameter for said development mix comprises computer-executable instructions for:
automatically determining an estimated total cost to construct structures of said development mix.

17. The computer-readable medium of claim 11, wherein said automatically determining said site build phase parameter of for said development mix site comprises computer-executable instructions for:
automatically determining a net present value of a build sequence of structures of said development mix.

18. The computer-readable medium of claim 11, wherein said automatically determining said site build phase parameter for said development mix comprises computer-executable instructions for:
utilizing said location of said site to automatically retrieve area specific performance information applicable to said development mix; and
determining said site build phase parameter based upon at least one element of said area specific performance information.

19. The computer-readable medium of claim 18, wherein said automatically determining said site build phase parameter for said development mix further comprises computer-executable instructions for:
determining a net present value of income streams for a plurality of build sequences of structures of said development mix; and
selecting a build sequence from said plurality of build sequences such that a net present value of said income streams is maximized.

20. The computer-readable medium of claim 11, wherein said automatically determining said site build phase parameter of for said development mix site comprises computer-executable instructions for:
automatically determining a cash flow of a build sequence of structures of said development mix.

21. A system for site development planning, said system comprising:
a user interface module configured for receiving site, location information from a user;
a development mix module configured for determining a development mix for developing a site, said development mix based upon a location of said site and regulatory information retrieved regarding said site location;
an earthworks module configured for estimating a site earthworks parameter for said development mix; and
a build module configured for determining a site build phase parameter for said development mix.

22. The system of claim 21, wherein said user interface is further configured for providing said development mix, said site earthworks parameter, and said build phase parameter as a site development planning output.

23. The system of claim 21, further comprising:
a coupling to a site planning information storage location.

24. A computer-implemented method for determining a development mix for a site, said method comprising:
receiving location information regarding a site;
based upon said location information, automatically retrieving regulatory information regarding said site; and
determining a mix of structures for building upon said site, said mix of structures determined based upon said location information and said regulatory information.

25. The method as recited in claim 24, further comprising:
automatically generating a site plan visualization for said site, said site plan visualization based upon said location information and said mix of structures.

26. The method as recited in claim 24, further comprising:
receiving a user input regarding a desired development type for said site.

27. The method as recited in claim 26, wherein said determining a mix of structures for building upon said site further comprises:
utilizing said desired development type as a constraint in determining said mix of structures for building upon said site.

28. The method as recited in claim 24, wherein said automatically retrieving regulatory information regarding said site comprises:
retrieving zoning information related to said site.

29. The method as recited in claim 24, wherein said automatically retrieving regulatory information regarding said site comprises:
retrieving state regulations related to development of said site.

30. The method as recited in claim 24, wherein said automatically retrieving regulatory information regarding said site comprises:
retrieving national regulations related to development of said site.

31. A computer-implemented method for estimating a site earthworks parameter, said method comprising:
receiving location information regarding a site;
utilizing said location information to automatically retrieve geographical information for said site;
receiving a site plan visualization regarding said site, said site plan visualization comprising a development mix;
automatically retrieving one or more earthmoving asset specifications; and
estimating said site earthworks parameter from said geographical information, said development mix, and at least one of said one or more earthmoving asset specifications.

32. The method as recited in claim 31, wherein said utilizing said location information to automatically retrieve geographical information for said site comprises:
utilizing said location information to retrieve topographical information related to said site.

33. The method as recited in claim 31, wherein said estimating said site earthworks parameter from said geographical information, said development mix, and at least one of said one or more earthmoving asset specifications further comprises:
receiving a user specified earthworks constraint regarding performance of earthworks for said site; and
estimating said site earthworks parameter from said geographical information, said development mix, said user specified earthworks constraint, and said at least one earthmoving asset specification.

34. The method as recited in claim 33, wherein said receiving a user specified earthworks constraint regarding performance of earthworks for said site comprises:
receiving said user specified earthworks constraint selected from the list of earthworks constraints consisting of: an earthmoving asset mix constraint, an earthworks schedule constraint, an earthworks personnel constraint, and an earthworks cost constraint.

35. The method as recited in claim 31, wherein said estimating said site earthworks comprises:
estimating a length of time required to perform said earthworks for said site.

36. The method as recited in claim 31, wherein said estimating said site earthworks parameter comprises:
estimating a cost to perform said earthworks for said site.

37. The method as recited in claim 31, wherein said estimating said site earthworks parameter comprises:
estimating an earthworks asset mix for performing said earthworks for said site.

38. A computer-implemented method for determining a site build phase parameter, said method comprising:
receiving location information regarding a site;
receiving a development mix regarding said site;
utilizing said location information to automatically retrieve area specific performance information applicable to said development mix; and
determining a site build phase parameter based upon at least one element of said area specific performance information.

39. The method as recite in claim 38, wherein said utilizing said location information to automatically retrieve area specific performance information applicable to said development mix comprises:
utilizing said location information to automatically retrieve area specific performance information selected from the group of area specific performance information consisting of: area specific rental rate information, area specific construction cost information, area specific construction timeline information, and area specific building permit information.

40. The method as recited in claim 38, wherein said determining a site build phase parameter comprises:
determining an estimated total cost to construct structures of said development mix.

41. The method as recited in claim 38, wherein said determining a site build phase parameter comprises:
determining estimated incomes for structures of said development mix based upon an occupancy rate for structures of said development mix.

42. The method as recited in claim 38, wherein said determining a site build phase parameter comprises:
determining a net present value of an income stream for a build sequence of said structures of said development mix.

43. The method as recited in claim 38, wherein said determining a site build phase parameter comprises:
determining a net present value of income streams for a plurality of build sequences of said structures of said development mix; and
determining a preferred build sequence for said structures of said development mix such that a net present value of said income streams is maximized.

44. The method as recited in claim 38, wherein said determining a site build phase parameter comprises:
determining a cash flow for a build sequence of said structures of said development mix.

45. The method as recited in claim 38, wherein said determining a site build phase parameter comprises:
determining an estimated timeline for completion a build sequence of said development mix.

46. The method as recited in claim 38, wherein said determining a site build phase parameter comprises:
determining a building permit needed for building a structure of said development mix.
